(19) United States
(12) Patent Application Publication
(10) Pub. No.: US 2026/0131761 A1
(43) Pub. Date: May 14, 2026

(54) AUTOMATIC CONDITION-BASED LENS CLEANING SYSTEM

(71) Applicant: Caterpillar Inc., Peoria, IL (US)

(72) Inventors: Jeffrey S. MAY, Aurora, IL (US); Cameron JENSEN, Granger, IN (US)

(73) Assignee: Caterpillar Inc., Peoria, IL (US)

(21) Appl. No.: 18/943,763

(22) Filed: Nov. 11, 2024

(51) Int. Cl. B60S 1/56

(52) U.S. Cl. CPC B60S 1/56

(57) ABSTRACT

Typically, when utilizing sensors or cameras for autonomous or remote-control operations in dirty environments, lenses are susceptible to dirt, dust, debris, and water collection on the lens that may lead to poor readings or visibility. Accordingly, an automatic condition-based lens cleaning system, comprising: a camera mounted on a loader and including a camera lens; a temperature sensor associated with the camera and configured to obtain temperature information; a lens cleaning device coupled to the camera; and a controller configured to: determine, based on the temperature information, whether an environmental temperature satisfies a temperature threshold that is associated with a high temperature application; and actuate the lens cleaning device to clean the camera lens based on determining that the environmental temperature satisfies the temperature threshold is disclosed.

### TECHNICAL FIELD

The embodiments described herein are generally directed to lens cleaning systems, and, more particularly, to an automatic condition-based lens cleaning system at industrial sites.

### BACKGROUND

In some industrial contexts, such as construction, mining, farming, forestry, and the like, work machines equipment may operate in remote locations, such as off-road locations, where debris and low visibility can create hazards. When utilizing sensors or cameras for work machines with autonomous or remote-control operations in dirty environments, lenses are susceptible to dirt, dust, debris, and water collection on the lens that may lead to poor readings or visibility. Access to these sites can potentially be a complex task when visibility is limited due to debris accumulation on camera lenses, resulting in blurred images or complete blockage, making it difficult for the system to function effectively. Therefore, having a debris or visibility blockage in the camera can lead to missed detections of hazards, and undermining the reliability of the system.

Traditionally, cleaning work machine cameras manually can be highly inefficient, especially in environments with frequent debris accumulation. This process often requires drivers to stop the work machine, disrupting the flow of travel and increasing downtime. Additionally, finding a safe and convenient spot for cleaning can be challenging in harsh weather or rugged terrains.

Accordingly, an automatic condition-based lens cleaning system has been developed to remove visibility obstruction in work machine cameras. For example, U.S. Pat. No. 11,661,038, published on May 30, 2023, describes a camera cleaning system controlled based on camera input, and U.S. Pat. No. 9,108,596, published on Aug. 18, 2015, describes cleaning system configured to provide signals indicative of conditions sensed or observed by the sensor/cameras with respect to a location. The present disclosure is directed toward overcoming one or more of the problems discovered by the inventor.

### SUMMARY

In an embodiment, an automatic condition-based lens cleaning system, comprising: a camera mounted on a loader and including a camera lens; a temperature sensor associated with the camera and configured to obtain temperature information; a lens cleaning device coupled to the camera; and a controller configured to: determine, based on the temperature information, whether an environmental temperature satisfies a temperature threshold that is associated with a high temperature application; and actuate the lens cleaning device to clean the camera lens based on determining that the environmental temperature satisfies the temperature threshold.

In an embodiment, a work machine with an automatic condition-based lens cleaning system, the system comprising: a work implement; a camera mounted on the work machine and including a camera lens; a temperature sensor associated with the camera and configured to obtain temperature information; a lens cleaning device coupled to the camera; and a controller configured to: determine, based on the temperature information, whether an environmental temperature satisfies a temperature threshold that is associated with a high temperature application; and actuate the lens cleaning device to clean the camera lens based on determining that the environmental temperature satisfies the temperature threshold.

In an embodiment, a method for automatic condition-based lens cleaning, the method comprising: mounting a camera on a loader and including a camera lens; obtaining temperature information with a temperature sensor associated with the camera; coupling a lens cleaning device to the camera; and with a controller, determining whether an environmental temperature satisfies a temperature threshold that is associated with a high temperature application based on the temperature information, and actuating the lens cleaning device to clean the camera lens based on determining that the environmental temperature satisfies the temperature threshold.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a side view of a work machine with an automatic condition-based lens cleaning system, according to an embodiment;

FIG. 2 illustrates an example architecture of a controller used in an automatic condition-based lens cleaning system, according to an embodiment;

FIG. 3 illustrates an example of an automatic condition-based lens cleaning system, according to an embodiment; and

FIG. 4 illustrate illustrates a data flow in a controller that controls an automatic condition-based lens cleaning system, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

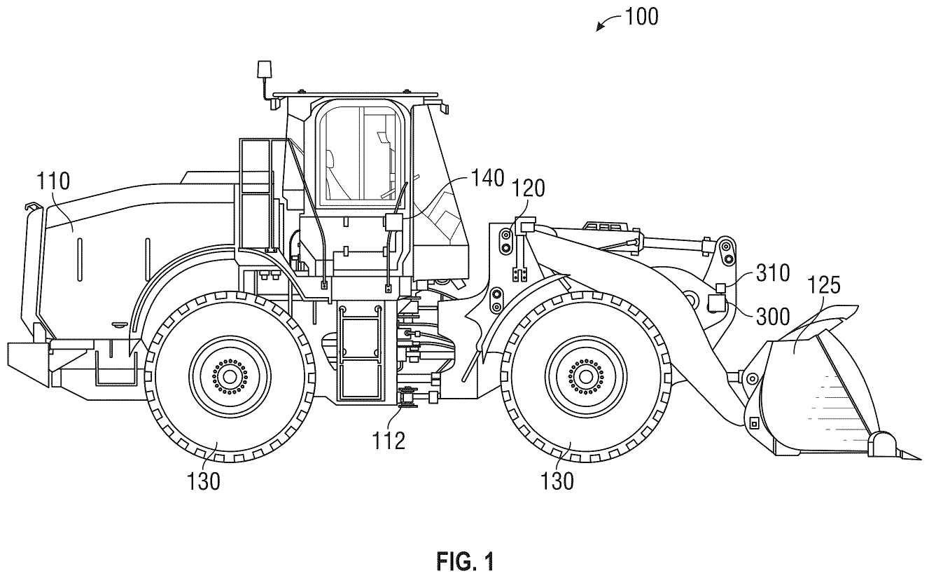

FIG. 1 illustrates a side view of a work machine with an automatic condition-based lens cleaning system, according to an embodiment. Work machine 100 is illustrated as a wheel loader. However, work machine 100 may be any equipment that is powered by an onboard battery pack. Other examples of work machine 100 include, without limitation, an excavator, dump truck, asphalt paver, backhoe loader, skid steer, track loader, cold planer, compactor, dozer, electric rope shovel, forest machine, hydraulic mining shovel, material handler, motor grader, pipe-layer, road reclaimer, telehandler, tractor-scraper, or the like. Work machine 100 may be operated by a human (e.g., locally or remotely) and/or by an autonomous system.

In the illustrated example, work machine 100 includes a rear portion 110 and a front portion 120 that includes a work tool 125. Front portion 120 may be articulated with respect to rear portion 110, by virtue of a joint 112, such that front portion 120 is capable of rotating within a range of degrees, relative to rear portion 110, around an axis. However, it should be understood that disclosed embodiments do not require work machine 100 to comprise an articulated front portion 120. In an alternative example, work machine 100 may comprise non-articulated front and rear potions (e.g., a single, integrated body frame).

In addition, work machine 100 comprises a work tool 125. Work tool 125 in work machine 100 can serve as an implement that performs specific tasks, enabling work machine 100 to accomplish its intended function efficiently. For instance, an example of a work machine 100 is a construction excavator, where the bucket acts as the primary work tool 125, allowing work machine 100 to dig, lift, and move materials. The design and material of work tool 125 can be tailored to withstand the stresses of heavy use, high temperatures, ensuring durability and effectiveness. Different work tools 125 include, but are not limited to, buckets, forks, and blades. Further, work tool 125 in work machine 100 can communicate with controller 140 through sensors that monitor various parameters, such as pressure, temperature, and position. These sensors send real-time data to controller 140 via a communication link using a communication protocol, such as CAN bus or Ethernet. Controller 140 processes this information to determine work tool's 125 operational status and detect work machine 100 activity, allowing for adjustments in performance or alerts for maintenance needs. The activities include at least one of digging, loading, or roading.

Work machine 100 may comprise at least one, and generally a plurality of, ground-engaging members 130. Ground-engaging members 130 are illustrated as wheels. In an alternative embodiment, ground-engaging members 130 may comprise a track or pair of tracks. More generally, ground-engaging member(s) 130 may comprise any mechanism for supporting work machine 100 above the ground, and preferably moving work machine 100 relative to the ground.

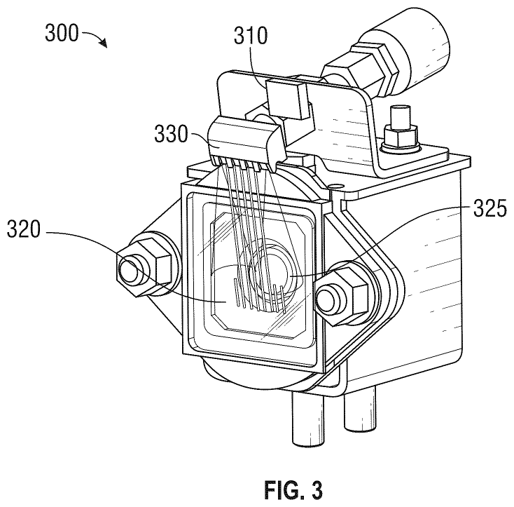

Moreover, work machine 100 comprises an automatic condition-based lens cleaning system 300. Automatic condition-based lens cleaning system 300 in a camera-equipped work machine 100 can assist in maintaining image quality and operational efficiency. Automatic condition-based lens cleaning system 300 primary function is to automatically remove dust, dirt, and other contaminants from lens 325 surface, ensuring that camera 320 captures clear and sharp images. Automatic condition-based lens cleaning system 300 can employ a lens cleaning device 330, such as air blowers, brushes, or specialized cleaning fluids, to effectively eliminate obstructions without damaging lens 325. Automatic condition-based lens cleaning system 300 enhances the accuracy of visual data captured for high-risks activities such as mining in high-temperature environments, ultimately contributing to better decision-making and productivity. Additionally, automatic condition-based lens cleaning system 300 can reduce downtime and repair costs. A detailed description of automatic condition-based lens cleaning system 300 is described in FIG. 3.

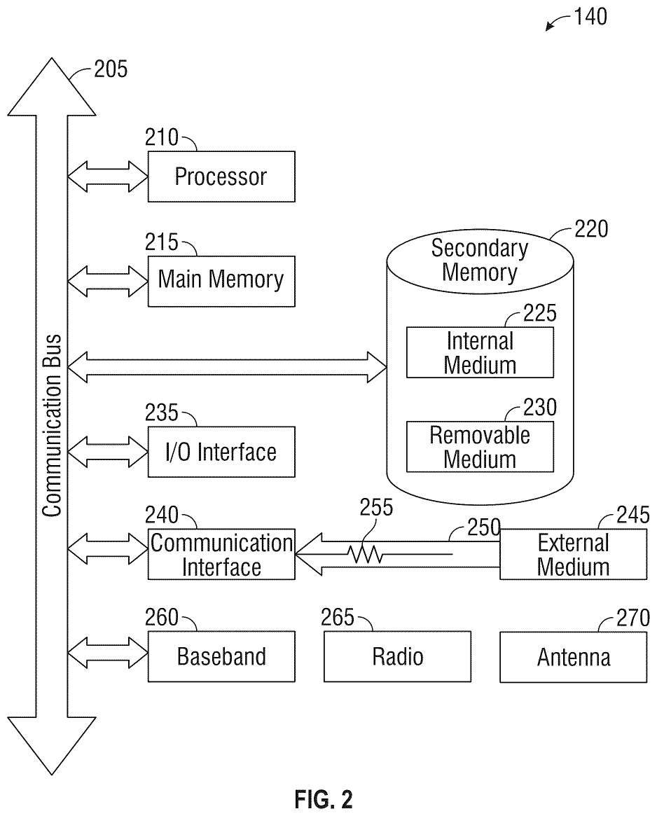

Further, automatic condition-based lens cleaning system 300 in work machine 100 comprises controller 140. Controller 140, or processor, in automatic condition-based lens cleaning system 300 functions as the central operating system, orchestrating and coordinating all operational activities. Controller 140 interprets input from various sensors and user commands, translating them into precise actions that drive work machine's 100 performance and automatic condition-based lens cleaning system 300 actuation. Further, controller 140 also enables automation features, allowing for tasks to be executed with minimal manual intervention such as actuating lens cleaning device 330. A detailed description of controller 140 is described in FIG. 2 below.

FIG. 2 illustrates an example architecture of a controller 140 used in an automatic condition-based lens cleaning system 300, according to an embodiment. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with controller 140 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 may be connected to a communication bus 205. Communication bus 605 may include a data channel for facilitating information transfer between storage and other peripheral components of machine controller 140. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

Machine controller 140 may comprise main memory 215. Main memory 215 provides storage of instructions and data for programs executing on processor 210, such as one or more of the processes or functions discussed herein. It should be understood that programs stored in the memory and executed by processor 210 may be written and/or compiled according to any suitable language, including without limitation C/C++, Java, JavaScript, Perl, Python, Visual Basic, . NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Machine controller 140 may comprise secondary memory 220. Secondary memory 220 is a non-transitory computer-readable medium having computer-executable code and/or other data (e.g., software implementing any process or function described herein) stored thereon. In this description, the term “computer-readable medium” is used to refer to any non-transitory computer-readable storage media used to provide computer-executable code and/or other data to or within controller 140. Computer-readable medium can include internal medium 225 and/or removable medium 230 The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Machine controller 140 may comprise an input/output (I/O) interface 235. I/O interface 235 provides an interface between one or more components of controller 140 and one or more input and/or output devices. For example, I/O interface 235 may receive the output of one or more sensors, and/or output control signals to one or more of the components of work machine 100.

Machine controller 140 may comprise a communication interface 240. Communication interface 240 allows signals, such as data and software, to be transferred between machine controller 140 and external devices, networks, or other information sources and/or destinations (e.g., receiver(s)). For example, computer-executable code and/or data may be transferred to machine controller 140, over one or more networks, from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing controller 140 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 120. Computer-executable code can also be received from an external system 245 via communication interface 240 and stored in main memory 215 and/or secondary memory 220. Such computer-executable code, when executed by processor(s) 210, enable machine controller 140 to perform the various processes or functions disclosed herein.

FIG. 3 illustrates an example of an automatic condition-based lens cleaning system 300, according to an embodiment. Automatic condition-based lens cleaning system 300 comprises a sensor 310 to sense environmental parameters, and a lens cleaning device 330 to clean lens 325 of camera 320. As previously described, automatic condition-based lens cleaning system 300 can assist in maintaining image quality and operational efficiency. Automatic condition-based lens cleaning system 300 primary function is to automatically remove dust, dirt, and other contaminants from lens 325 surface, ensuring that camera 320 captures clear and sharp images. Automatic condition-based lens cleaning system 300 can employ a lens cleaning device 330, such as air blowers, brushes, or specialized cleaning fluids, to effectively eliminate obstructions without damaging lens 325. It should be understood that automatic condition-based lens cleaning system 300 can comprise different designs, and FIG. 3 provides an example of condition-based lens cleaning system 300 applications.

Automatic condition-based lens cleaning system 300 comprises sensor 310. Sensor 310 can detect environmental temperature, humidity, and light functions by using specialized components to measure each parameter. For environmental temperature, sensor 310 can employ thermistors or thermocouples to gauge temperature, hygrometers to assess humidity levels, and photodetectors or photodiodes to measure light intensity. Sensor 310 can collect this data in real time, allowing for monitoring of environmental conditions. Sensor's 310 information can be used to actuate lens cleaning device 330. Further, sensor 310 can utilize thermistors for precise temperature readings, hygrometers for humidity detection, and photodetectors to measure ambient light intensity. In addition, sensor 310 can transmit data to controller 140 for detecting a particular activity being performed by work machine 100. Sensor 310 can be equipped with wireless connectivity to transmits real-time data to a centralized platform or controller 140, allowing users to track environmental changes and make informed decisions or automatic actuation of lens cleaning device 330. Examples of sensor 310 include, but are not limited to, the DHT22 and the BME280 sensor for measuring temperature and humidity.

Camera 320 captures images of the environments where work machine 100 is operating. Camera 320 can be integrated into work machine 320 and serves multiple functions, enhancing both operational efficiency and safety. Camera 320 can provide real-time visual feedback, allowing operators to monitor work machine's 100 surroundings, identify potential hazards, and make informed decisions while working in high-risk environments. Further, camera 320 can be used for remote management. In these cases, camera 320 can transmit live video feeds to controller 140, a central control system or a mobile device, enabling operators to oversee operations, troubleshoot issues, and guide work machine 100 from a distance. Commercially available models of camera 320 for work machines include the CAT® VisionLink, designed for heavy equipment monitoring. Further, camera 320 includes camera lens 325. Camera lens 325 in work machine's 100 camera 320 can capture clear and accurate images by focusing light onto the sensor. For further protection against hostile environments, camera lens 325 can include a glass camera shield to avoid damage to camera 320 and/or camera lens 325.

Lens cleaning device 330 can be coupled to camera 320. Lens cleaning tool 330 is designed to maintain the clarity and performance of camera 320 by removing dust, fingerprints, smudges, and other contaminants from camera lens 325. Lens cleaning device 330 can comprise an air nozzle or air pressure device that utilizes a mechanism that generates a controlled stream of compressed air to dislodge particulate matter from camera lens 325, minimizing the risk of abrasion. Further, lens cleaning device 330 can include whippers with a microfiber applicator designed for efficient removal of contaminants such as oils and debris, employing a non-abrasive contact method to maintain optical integrity in camera lens 325. On the other hand, lens cleaning device 330 can comprise a nozzle system to dispense a fine mist of cleaning solution, facilitating uniform coverage across camera lens 325. Lens cleaning device 330 can be actuated by controller 140 through a series of conditions when said conditions are met. For example, lens cleaning device 330 can be actuated by controller 140 when sensor 310 detects a temperature above 85 degrees Fahrenheit.

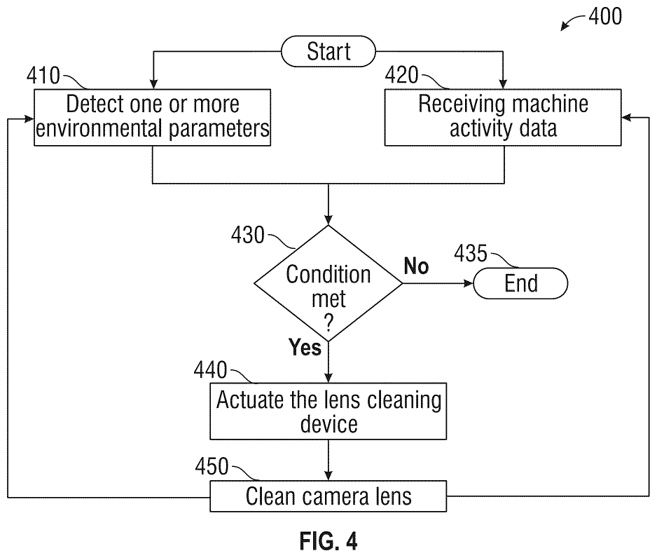

FIG. 4 illustrates a data flow in a controller that controls an automatic condition-based lens cleaning system, according to an embodiment. In subprocess 410, sensor 310 can detect one or more environmental parameters that can include temperature, humidity, pressure, or a combination of the previous parameters. It should be noted that these parameters can include other available indicators depending on the activity being performed by work machine 100. Further, in subprocess 420, controller 140 can detect work machine 100 activity based on the parameters detected by sensor 310. Controller 140 can be configured to process the parameters received from sensor 310 and determine if any of the conditions are met, as shown in subprocess 430.

In subprocess 435, if none of the conditions are met, then there is no actuation of lens cleaning device 330. On the other hand, in subprocess 440, if any of the conditions are met, then controller 140 actuates lens cleaning device 330 to clean camera lens 325, as shown in subprocess 450.

### INDUSTRIAL APPLICABILITY

In some industrial contexts, such as construction, mining, farming, forestry, and the like, work machines 100 equipment may operate in remote locations, such as off-road locations, where debris and low visibility can create hazards. When utilizing sensors 310 or cameras 320 for work machines 100 with autonomous or remote-control operations in dirty environments, lenses are susceptible to dirt, dust, debris, and water collection on camera lens 325 that may lead to poor readings or visibility. Accordingly, disclosed embodiments provide an automatic condition-based lens cleaning system 300, comprising a camera 320 mounted on a work machine 100 and including a camera lens 325; a temperature sensor 310 associated with camera 320 and configured to obtain temperature information; a lens cleaning device 330 coupled to camera 320; and a controller 140.

The industrial applicability of automatic condition-based lens cleaning system 300 in work machines 100 can assist particularly in environments where visibility is critical for safety and efficiency. Work machines 100 such as construction equipment, agricultural vehicles, and drones often operate in dusty or dirty conditions, leading to rapid camera lens 325 contamination. Automatic condition-based lens cleaning system 300 enhances operational reliability by ensuring that visibility remains clear, thus improving the accuracy of navigation, obstacle detection, and monitoring functions.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in an electric work machine, it will be appreciated that it can be implemented in various other types of equipment and machines with batteries, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. An automatic condition-based lens cleaning system, comprising:
a camera mounted on a loader and including a camera lens;
a temperature sensor associated with the camera and configured to obtain temperature information;
a lens cleaning device coupled to the camera; and
a controller configured to:
determine, based on the temperature information, whether an environmental temperature satisfies a temperature threshold that is associated with a high temperature application; and
actuate the lens cleaning device to clean the camera lens based on determining that the environmental temperature satisfies the temperature threshold.

2. The automatic condition-based lens cleaning system of claim 1, wherein the controller is further configured to:
determine, based on operating information from a machine controller associated with the loader, whether the loader is engaged in a particular activity that is consistent with the high temperature application; and
actuate the lens cleaning device based on determining that the loader is engaged in the particular activity.

3. The automatic condition-based lens cleaning system of claim 2, wherein the particular activity includes at least one of digging, loading, or roading.

4. The automatic condition-based lens cleaning system of claim 1, further comprising a light sensor associated with the camera and configured to obtain light information, wherein the controller is further configured to:
determine, based on the light information, whether an environmental lighting satisfies a lighting threshold that is associated with the high temperature application; and
actuate the lens cleaning device based on determining that the environmental lighting satisfies the lighting threshold.

5. The automatic condition-based lens cleaning system of claim 1, further comprising a humidity sensor associated with the camera and configured to obtain humidity information, wherein the controller is further configured to:
determine, based on the humidity information, whether an environmental humidity satisfies a humidity threshold that is associated with the high temperature application; and
actuate the lens cleaning device based on determining that the environmental humidity satisfies the humidity threshold.

6. The automatic condition-based lens cleaning system of claim 1, further comprising a glass camera shield.

7. The automatic condition-based lens cleaning system of claim 1, wherein the lens cleaning device comprises an air nozzle configured to clean the camera lens with pressurized air.

8. The automatic condition-based lens cleaning system of claim 1, wherein the information received by the controller is wireless.

9. The automatic condition-based lens cleaning system of claim 1, wherein the temperature threshold is 85 degrees Fahrenheit or more.

10. A work machine with an automatic condition-based lens cleaning system, the system comprising:
a work implement;
a camera mounted on the work machine and including a camera lens;
a temperature sensor associated with the camera and configured to obtain temperature information;
a lens cleaning device coupled to the camera; and
a controller configured to:
determine, based on the temperature information, whether an environmental temperature satisfies a temperature threshold that is associated with a high temperature application; and
actuate the lens cleaning device to clean the camera lens based on determining that the environmental temperature satisfies the temperature threshold.

11. The work machine with an automatic condition-based lens cleaning system of claim 1, wherein the controller is further configured to:
determine, based on operating information from a machine controller associated with the loader, whether the loader is engaged in a particular activity that is consistent with the high temperature application; and
actuate the lens cleaning device based on determining that the loader is engaged in the particular activity.

12. The work machine with an automatic condition-based lens cleaning system of claim 11, wherein the particular activity includes at least one of digging, loading, or roading.

13. The work machine with an automatic condition-based lens cleaning system of claim 10, further comprising a light sensor associated with the camera and configured to obtain light information, wherein the controller is further configured to:
determine, based on the light information, whether an environmental lighting satisfies a lighting threshold that is associated with the high temperature application; and
actuate the lens cleaning device based on determining that the environmental lighting satisfies the lighting threshold.

14. The work machine with an automatic condition-based lens cleaning system of claim 10, further comprising a humidity sensor associated with the camera and configured to obtain humidity information, wherein the controller is further configured to:
determine, based on the humidity information, whether an environmental humidity satisfies a humidity threshold that is associated with the high temperature application; and
actuate the lens cleaning device based on determining that the environmental humidity satisfies the humidity threshold.

15. A method for automatic condition-based lens cleaning, the method comprising:
mounting a camera on a loader and including a camera lens;
obtaining temperature information with a temperature sensor associated with the camera;
coupling a lens cleaning device to the camera; and
with a controller, determining whether an environmental temperature satisfies a temperature threshold that is associated with a high temperature application based on the temperature information, and actuating the lens cleaning device to clean the camera lens based on determining that the environmental temperature satisfies the temperature threshold.

16. The method for automatic condition-based lens cleaning of claim 15, wherein the controller is further configured to:
determining, based on operating information from a machine controller associated with the loader, whether the loader is engaged in a particular activity that is consistent with the high temperature application; and
actuating the lens cleaning device based on determining that the loader is engaged in the particular activity.

17. The method for automatic condition-based lens cleaning of claim 16, wherein the particular activity includes at least one of digging, loading, or roading.

18. The method for automatic condition-based lens cleaning of claim 15, further comprising a light sensor associated with the camera and configured to obtain light information, wherein the controller is further configured to:
determining, based on the light information, whether an environmental lighting satisfies a lighting threshold that is associated with the high temperature application; and
actuating the lens cleaning device based on determining that the environmental lighting satisfies the lighting threshold.

19. The method for automatic condition-based lens cleaning of claim 15, further comprising a humidity sensor associated with the camera and configured to obtain humidity information, wherein the controller is further configured to:
determining, based on the humidity information, whether an environmental humidity satisfies a humidity threshold that is associated with the high temperature application; and
actuating the lens cleaning device based on determining that the environmental humidity satisfies the humidity threshold.

20. The method for automatic condition-based lens cleaning of claim 15, wherein the lens cleaning device comprises an air nozzle configured to clean the camera lens with pressurized air.
